(19) United States
(12) Patent Application Publication
(10) Pub. No.: US 2002/0102329 A1
(43) Pub. Date: Aug. 1, 2002

(54) Methods for high-temperature hydrolysis of galactose-containing oligosaccharides in complex mixtures

(76) Inventors: Michael Lanahan, Research Triangle Park, NC (US); Edward S. Miller JR., Raleigh, NC (US); Robert M. Kelly, Cary, NC (US)

Correspondence Address: MYERS BIGEL SIBLEY & SAJOVEC, PO BOX 37428, RALEIGH, NC, 27627, US

(21) Appl. No.: 09/909,464

(22) Filed: Jul. 19, 2001

Related U.S. Application Data
(60) Provisional application No. 60/220,211, filed on Jul. 22, 2000.

(51) Int. Cl. A23L 1/20

(52) U.S. Cl. 426/46; 426/54

(57) ABSTRACT

α-galactosidases from hyperthermophilic sources are useful in treating animal feed by hydrolyzing the galactose oligosaccharides present in animal feeds. α-galactosidases from Thermotoga maritima are useful in hydrolyzing raffinose, stachyose and verbascose, indigestible oligosaccharides commonly found in animal feed compositions. The ability to use these enzymes at high temperatures, namely those that would normally be encountered in industrial processes typically associated with animal feed formulation or processing, is advantageous for adding nutritive value to animal feed and flexibility in processing. Hyperthermophilic α-galactosidases are also useful as food additives for human food.

### RELATED APPLICATIONS

This application claims the benefit of U.S. Provisional Application No. 60/220,211, filed Jul. 22, 2000, the disclosure of which is incorporated herein by reference in its entirety.

### FIELD OF THE INVENTION

This invention relates to the processing of animal feeds and other complex substrates by utilizing hyperthermophilic enzymes to hydrolyze oligosaccharides.

### BACKGROUND OF THE INVENTION

α-galactosidase (also interchangeably referred to herein as α-D-galactoside galactohydrolase, EC 3.2.1.22, α-gal or Gal36) is an exo-acting glycosidase that catalyzes the hydrolysis of α-1→6 linked α-D-galactosyl residues from the non-reducing end of simple galactose-containing oligosaccharides. Examples of these oligosaccharides include raffinose, stachyose, verbascose and melibiose, as well as more complex polysaccharides.

Intracellular and extracellular α-gals are widely distributed in microorganisms, plants, and animals. Genes encoding α-gals have been cloned from various sources, including humans, plants, yeasts, filamentous fungi, and bacteria. Based on similarities in primary structure and hydrophobic cluster analyses, α-gals have been grouped into three well-conserved families in the general classification of glycosyl hydrolases. Those from bacteria have been grouped into the families 4 and 36, and those of eukaryotic origin into family 27.

The isolation of the bacterium Thermotoga maritima is described in Huber et al., Arch. Microbiol. 144, 324-333 (1986). T. maritima is a eubacterium that is strictly anaerobic, rod-shaped, fermentative, hyperthermophilic, and grows between 55° C. and 90° C., with an optimum growth temperature of about 80° C. This eubacterium has been isolated from geothermally heated sea floors in Italy and the Azores. Thermotoga neopolitana is another hyperthermophilic eubacterium related to T. maritima. Enzymes that have been isolated from both T. maritima and T. neopolitana include β-mannanases, β-mannosidase, α-galactosidases, and hemicellulases. Of the known α-gals, only the α-gals of the hyperthermophilic bacteria T. maritima (TmGalA) and T. neapolitana (TnGalA) have demonstrated activity and prolonged stability above 75° C.

Animal feed formulations are generally created with balanced carbohydrate and protein contents, and are adjusted to fit the various stages in the life cycle of a particular animal. In many animal feeds, soybean meal comprises a significant amount of the feed. For example, in broiler chicken diets, soybean meal constitutes roughly 20 to 30% of the protein content. Soybeans are high in protein, and in particular are high in the amino acids lysine and threonine but low in methionine. The high protein content is the reason for the extensive use of soybean in animal and human feeds (e.g., baby formula). It is estimated that U.S. production of soybean meal is a $6 billion dollar industry, with about 80% of U.S. annual soybean meal production being used in animal feeds.

Roughly 15% of soy meal is not digestible by monogastric animals. This 15% constitutes the dietary fiber (as insoluble fiber) in the poultry diet. Generally, about three to five percent of this insoluble fraction are the raffino-oligosaccharides. In other feeds, such as those that are legume or wheat based, the raffino-oligosaccharide content is much higher, on the order of 35%, and constitute the bulk of the anti-nutritive carbohydrates in those particular types of feed.

The presence of undigested oligosaccharides may have undesirable consequences with regard to optimal energy utilization of animal feeds. Enzymatic treatment of animal feeds may allow for the increased availability of digestible and soluble carbohydrates. Small gains in apparent metabolizable energy (AME) content of a feed may generate significant cost savings. By minimizing feed consumption, increased AME may be obtained by removing anti-nutritive factors (i.e., indigestible oligosaccharides), improving digestibility of available carbohydrate components, and improving the water solubility of insoluble fractions.

A general scheme of a typical soybean meal processing sequence, illustrated in FIG. 7, is typical of animal feed processing in general. During the processing of animal feeds, and in particular animal feeds comprising soy meal, the feed is treated with boiling hexane to remove the oils present in the soybean matter (i.e., flakes). The hexane is then distilled off from the oils and recovered. Following hexane treatment, the feed is then treated with steam for one to two minutes to denature proteins and destroy protease inhibitors. The heat treatment is primarily aimed at denaturing the protease inhibitors that are found in the meal. This is especially true of soybeans, which contain an overabundance of proteases and protease inhibitors. During this step, the moisture content is raised to about 20%, which is generally the highest water content step in all of animal feed processing. Residual urease activity is generally used as a measure to determine the degree of protein denaturation. Following steam treatment, the feed is then sent to a desolventizer/toaster. Here, the feed is heated or “cooked” to drive off any remaining hexane and to reduce the water content to roughly 14%. Further protein denaturation takes place in this step. Following the toaster operation, the feed is pelleted (e.g., by extrusion) at temperatures around 180° F. (82° C.). The pelleting or extruding process generally lasts on the order of tens of seconds. Following cooling, the water content may be reduced another 2% to about 12% total moisture content.

Present technologies for the enzymatic treatment of animal feeds generally use enzymes from mesophilic sources to create animal feeds with improved digestibility and nutrient value. These enzymes generally must be applied in the final processing step of feed formulation following pelleting, due to the relatively low thermostability of the enzymes and the high temperatures involved in feed processing. The physical process of pelleting generally involves heating the feed and extruding it through a die. The high temperature is necessary to drive off excess moisture that would otherwise prohibit the pellet from staying together and to ‘melt’ the feed into a pellet. Most pelleting equipment can process roughly 1,000 kg/hr of feed. Enzymes are added to the newly formed pellets as the pellets fall from the pelleter and air-cool. Usually, the enzyme solution is sprayed from a nozzle perpendicular to the falling feed pellets. Coating the pellets with enzyme in this manner is an inefficient process in that (1) the rate of enzyme application is limited by the water content of the enzyme solution (if the pellets get too wet they fall apart, and a high water content in the pellet promotes mold and fungal growth upon storage), and (2) due to this limitation and the high rate of pellets formed, feed pellets are often incompletely coated with enzyme. When this technique is used, it is estimated that only about one in five pellets is actually coated with enzyme.

Additionally, mesophilic enzymes are generally targeted for activity inside the animal (i.e., post-digestion). Because of the pH and the presence of proteases inside the digestive tract of the animal, the exogenously applied enzymes are rendered considerably less effective. Accordingly, a need exists for enzymatic applications to animal feed wherein the indigestible oligosaccharides are broken into monomers prior to ingestion by the animal, and wherein the enzymes are stable at the high temperatures used in feed processing.

In addition to reducing the apparent metabolizable energy (AME) content in human and animal food, the presence of indigestible oligosaccharides in human and animal food is also undesirable because of gastrointestinal distress (e.g., flatulence and other gastrointestinal symptoms) caused by the presence of the oligosaccharides. Certain foods that are flatugenic include legumes (e.g., peanuts, beans), some cruciferous vegetables (e.g., cabbage, brussels sprouts) and certain fruits (e.g., raisins, bananas, apricots). The primary cause of flatulence from the previously mentioned foods is the body's inability to digest certain carbohydrates (i.e., raffinose, stachyose and verbascose) contained within these foods. The mammalian inability to digest these carbohydrates allows putrefactive bacteria in the large intestine to break down these carbohydrates by fermentation. This results in the formation of excessive levels of rectal gas, primarily carbon dioxide, methane and hydrogen. Humans and other monogastric mammals have difficulty digesting the three oligosaccharides to liberate D-galactose, since their digestive systems either do not produce α-galactosidase or produce it in negligible quantities.

In vitro uses of α-galactosidase to render the previously-mentioned oligosaccharides digestible are known. U.S. Pat. Nos. 3,966,555; 4,241,185; and 4,431,737 each disclose methods of producing and/or stabilizing α-galactosidase by culturing of various microorganisms and suggest that α-D-galactosidase can be used in vitro in food processing and/or by addition to foodstuffs for a period of up to 12 hours. In vitro hydrolysis of α-D-galactoside-linked sugars with the addition of α-galactosidase is described in R. Cruz, et al., Journal of Food Science 46, 1196-1200 (1981).

U.S. Pat. No. 5,436,003 to Rohde et al. describes a method of alleviating gastrointestinal distress with a composition containing β-fructofuranosidase, cellulase and hemi-cellulase. A liquid product sold under the trademark BEANO® by AkPharma has been described as an enzyme or food additive that reduces or eliminates the intestinal gas produced when foods such as beans, broccoli, bran and other vegetables and grains that are a staple in healthy low-fat, high-fiber diets, are eaten. The BEANO® product contains the enzyme α-galactosidase obtained from Aspergillus niger.

Unfortunately, there are certain problems associated with known in vitro processing of foods with α-galactosidase in order to hydrolyze α-D-galactoside-linked sugars and to reduce symptoms in mammals ingesting them. In general, the enzyme is applied to foods that have already been prepared (i.e., cooked). The treatment of intact (i.e., unmacerated or unchewed) beans or other vegetables and fruits by enzymatic means is inefficient and costly. The solid nature of these foods precludes efficient, uniform and completely effective enzyme activity in that the enzyme has only external contact with the substrate. Finally, the present methods of using α-galactosidases generally involve the application of the enzyme immediately prior to the consumption of the food; thus, the activity of the enzyme occurs primarily after consumption and during digestion. Currently used products are not able to be applied to the foods prior to preparation (i.e., cooking, heating) of the food due to the thermal instability of the mesophilic α-galactosidases at high temperatures. The ability to use an α-galactosidase that is stable at high temperatures is desirable because it provides the consumer of food additional flexibility in (1) the preparation of foods containing undesirable oligosaccharides and (2) the ability to hydrolyze unwanted oligosaccharides prior to digestion.

### SUMMARY OF THE INVENTION

The present inventors have discovered that certain hyperthermophilic enzymes have applications as processing additives that improve the quality of animal feed and human food. The invention utilizes α-galactosidases from hyperthermophilic sources, for example, α-galactosidase from Thermotoga maritima DSM3109, to directly treat animal feed by hydrolyzing the galactose-containing oligosaccharides present in animal feeds. Enzymatic treatment is accomplished by the addition of a hyperthermophilic α-galactosidase preparation directly to the substrate composition comprising the galactose-containing oligosaccharides (such as animal feed containing soybean meal). One advantage of the invention is the ability to use the enzyme at high temperatures, namely those that would normally be encountered in industrial processes typically associated with animal feed formulation or processing.

Additionally, at these higher temperatures the substrate is more completely accessible to the enzyme, allowing the enzyme to come into complete contact with the substrate. Moisture requirements for enzyme activity are generally reduced at the elevated temperatures that are necessary for enzyme activity. The extent of enzyme activity on the substrate may also be controlled by modulating the time at which the mixture is held at the elevated temperatures.

Accordingly, one aspect of the invention is a new process for hydrolyzing galactose-containing oligosaccharides by contacting a hyperthermophilic α-galactosidase with a complex substrate (e.g., animal feed) comprising galactose-containing oligosaccharides, and then heating the mixture to facilitate enzyme-mediated hydrolysis.

Another aspect of the invention is a composition comprising a mixture of hyperthermophilic α-galactosidase and complex substrates comprising galactose-containing oligosaccharides (such as soy meal, soy flakes or animal feed).

A third aspect of the invention is a composition comprising α-galactosidases from hyperthermophilic sources that may be used as a food additive to decrease gastrointestinal distress in humans and animals.

Yet a fourth aspect of the invention is a composition comprising α-galactosidases from hyperthermophilic sources that may be used as a processing additive in, for example, the isolation of vegetable protein (i.e., soy protein). Such an additive is useful in facilitating the removal of oligosaccharides and galactose monomers from the protein products, thus preventing or decreasing gastrointestinal distress in humans and animals

Because of the high thermostability of the enzymes disclosed herein, and the high temperature at which the enzymes are active, the invention allows for enzymatic modification of animal feed to take place during high temperature feed processing prior to feeding the material to the animal. Storage problems arising from increased moisture content are reduced or eliminated as post-pelleting enzyme application is no longer necessary. Increased enzymatic efficiency is realized due to reduced mass transfer resistance, as smaller particles are treated (i.e., as compared to the finished pelleted product). Finally, the hydrolysis of galactose-containing oligosaccharides leads ultimately to increased value in the sense that the feed is more nutritive (i.e., is more useful food energy available to animals).

The foregoing and other aspects of the present invention are explained in detail in the specification set forth below.

### BRIEF DESCRIPTION OF THE DRAWINGS

FIG. 1A is the nucleotide sequence of Thermotoga maritima DSM 3109 galA or gal36 gene (SEQ ID NO: 1). The amino acid sequence encoded thereby is shown in FIG. 1B (SEQ ID NO: 2). The nucleotide sequence begins with translation initiation codon, GTG. Upstream ribosomal binding site sequences have been omitted. During cloning of this gene as described herein, the translation initiation codon GTG, was changed to ATG to facilitate insertion into the unique NcoI site in pET24d+ immediately following the ribosomal binding site.

FIG. 2 is a 12% SDS-PAGE gel of heat-treated, recombinant Thermotoga maritima DSM3109 GalA. Lane 1 comprises the Tm GalA enzyme preparation after heat treatment for 30 minutes at 80° C. Lane 2 comprises molecular weight markers. Lane 3 comprises the E. coli BL21(λDE3)/pESM26 crude cell extract.

FIG. 3 is a graphical illustration of Thermotoga maritima Gal A activity on PNP-galactose as a function of pH. The following buffers were used: for pH range 2.5 to 3.5, 50 mM citrate; for pH range 4 to 6, 50 mM Na acetate; for pH range 6.5 to 8, 50 mM Na phosphate.

FIG. 4 is a graphical illustration of Thermotoga maritima Gal A activity on PNP-galactose as a function of temperature. All assays were conducted with 50 mM Na acetate buffer, 0.1M NaCl and 1 mM PNP-galactose.

FIG. 5 is a schematic representation of the raffinose series of oligosaccharides.

FIGS. 6A through 6D are time course HPLC chromatograms of resolubilized, 80% ethanol extracted chicken feed components either undigested or digested with 15 units TmGal A. The values labeled on the y-axis represent millivolts, while the values labeled on the x axis represent minutes elapsed. In FIG. 6A, the time course of a negative control at t=0 is illustrated. In FIG. 6B, the time course of a negative control after one hour is illustrated. Components with retention times of approximately 37 minutes, approximately 42 minutes, and approximately 47 minutes have been identified as stachyose, sucrose, and galactose, respectively. In FIG. 6C, the time course of an enzyme treated sample at t=0 is illustrated. In FIG. 6D, the time course of an enzyme treated sample after one hour is illustrated. Components with retention times of approximately 37 minutes, approximately 42 minutes, and approximately 47 minutes have been identified as stachyose, sucrose, and galactose, respectively.

FIG. 7 is a schematic representation of a typical industrial method of soybean meal processing.

### DETAILED DESCRIPTION OF THE PREFERRED EMBODIMENTS

The present invention will now be described more fully hereinafter with reference to the accompanying drawings and specification, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

Except as otherwise indicated, standard methods may be used for the production of cloned genes, expression cassettes, vectors (e.g., plasmids), proteins and protein fragments according to the present invention. Such techniques are known to those skilled in the art (see e.g., Sambrook et al., eds., Molecular Cloning: A Laboratory Manual Second Edition (Cold Spring Harbor, N.Y. 1989); F. M. Ausubel et al., eds., Current Protocols In Molecular Biology (Green Publishing Associates, Inc. and John Wiley & Sons, Inc., New York 1991).

Amino acid sequences disclosed herein are presented in the amino to carboxy direction, from left to right. The amino and carboxy groups are not presented in the sequence. Nucleotide sequences are presented herein by single strand only, in the 5′ to 3′ direction, from left to right. Nucleotides and amino acids are represented herein in the manner recommended by the IUPAC-IUB Biochemical Nomenclature Commission, or (for amino acids) by three letter code, in accordance with 37 CFR §1.822 and established usage. See, e.g., Patentln User Manual, 99-102 (Nov. 1990) (U.S. Patent and Trademark Office).

A. Definitions

By “protein” or “enzyme” herein is meant at least two covalently attached amino acids, which includes proteins, polypeptides, oligopeptides and peptides. The protein may be made up of naturally occurring amino acids and peptide bonds, or synthetic peptidomimetic structures. Thus “amino acid,” or “peptide residue,” as used herein, means both naturally occurring and synthetic amino acids. “Amino acid” also includes imino acid residues such as proline and hydroxyproline. The side chains may be in either the (R) or the (S) configuration. If non-naturally occurring side chains are used, non-amino acid substituents may be used, for example to prevent or retard in vivo degradations. Chemical blocking groups or other chemical substituents may also be added.

“Amino acid sequence,” as used herein, refers to an oligopeptide, peptide, polypeptide, or protein sequence, and fragment thereof, and to naturally occurring or synthetic molecules. Fragments of α-galactosidase preferably retain the biological activity of α-galactosidase. Where “amino acid sequence” is recited herein to refer to an amino acid sequence of a naturally occurring protein molecule, amino acid sequence, and like terms, are not meant to limit the amino acid sequence to the complete, native amino acid sequence associated with the recited protein molecule.

“Amplification,” as used herein, refers to the production of additional copies of a nucleic acid sequence and is generally carried out using polymerase chain reaction (PCR) technologies well known in the art (Dieffenbach, C. W. and G. S. Dveksler (1995) PCR Primer, A Laboratory Manual, Cold Spring Harbor Press, Plainview, N.Y.).

The term “nucleic acid derivative,” as used herein, refers to the chemical modification of a nucleic acid encoding or complementary to α-galactosidase or the encoded α-galactosidase. Such modifications include, for example, replacement of hydrogen by an alkyl, acyl, or amino group. A nucleic acid derivative encodes a polypeptide which retains the biological or immunological function of the natural molecule. A derivative polypeptide is one which is modified by glycosylation, pegylation, or any similar process which retains the biological or immunological function of the polypeptide from which it was derived.

The term “homology,” as used herein, refers to a degree of complementarity. There may be partial homology or complete homology (i.e., identity). A partially complementary sequence that at least partially inhibits an identical sequence from hybridizing to a target nucleic acid is referred to using the functional term “substantially homologous.” The inhibition of hybridization of the completely complementary sequence to the target sequence may be examined using a hybridization assay (Southern or northern blot, solution hybridization and the like) under conditions of low stringency. A substantially homologous sequence or hybridization probe will compete for and inhibit the binding of a completely homologous sequence to the target sequence under conditions of low stringency. This is not to say that conditions of low stringency are such that non-specific binding is permitted; low stringency conditions require that the binding of two sequences to one another be a specific (i.e., selective) interaction. The absence of non-specific binding may be tested by the use of a second target sequence which lacks even a partial degree of complementarity (e.g., less than about 30% identity). In the absence of non-specific binding, the probe will not hybridize to the second non-complementary target sequence.

By “nucleic acid” or “oligonucleotide” or grammatical equivalents herein means at least two nucleotides covalently linked together. A nucleic acid of the present invention will generally contain phosphodiester bonds, although in some cases, nucleic acid analogs are included that may have alternate backbones known in the art (e.g., phosphoramide; phosphorothioate; phosphorodithioate; O-methylphophoroamidite linkages, and peptide nucleic acid backbones and linkages

“Nucleic acid sequence” and “polynucleotide” are used interchangeably herein to refer to an oligonucleotide, nucleotide, or polynucleotide, and fragments thereof, and to DNA or RNA of genomic or synthetic origin which may be single- or double-stranded, and represent the sense or antisense strand.

As used herein, the term “hydrolyzing” refers to the removal via enzymatic activity of an α-D-galactosyl residue from the non-reducing end of an oligosaccharide comprising galactose units. In an oligosaccharide, hydrolysis of the oligosaccharide means that the degree of polymerization (DP) of the oligosaccharide is decreased. The reduction of the degree of polymerization may mean that the oligosaccharide is hydrolyzed into a smaller oligosaccharide, and preferably means that the oligosaccharide is completely hydrolyzed into its monomer galactose units.

The term “substrate,” as used herein, refers to compounds or mixtures comprising oligosaccharides, in particular the oligosaccharides stachyose, raffinose and verbascose. Exemplary substrates particularly described in this application include oilseed meal (i.e., soybean meal, canola meal), vegetable protein flakes, animal feed and human food in any form.

Soybean, or Glycine max, is used as an exemplary source of substrates for the present invention, although other substrate sources such as canola, rape seed, sunflower seed, linseed, safflower seed, sesame seed and cofton seed may also be the source of substrates according to the present invention. Accordingly, terms such as “meal,” “oil,” “flake,” “feed,” “protein,” and “product” that are defined in terms of soybean are also applicable to other substrate sources. In general, suitable sources of substrates are preferably oilseeds, although the invention is also useful in conjunction with other sources of substrates.

As used herein, the term “soybean product” is any product, edible or otherwise, which has soybean as its natural source. Accordingly, “soybean product” may encompass soybean meal, soybean oil, soybean flakes, soybean flakes, soy grits, soy proteins and protein concentrates, soy lecithin, soy hulls, soy isolates or concentrates, soy curd, or any animal feed or human food that comprises a soy product such as soybean meal.

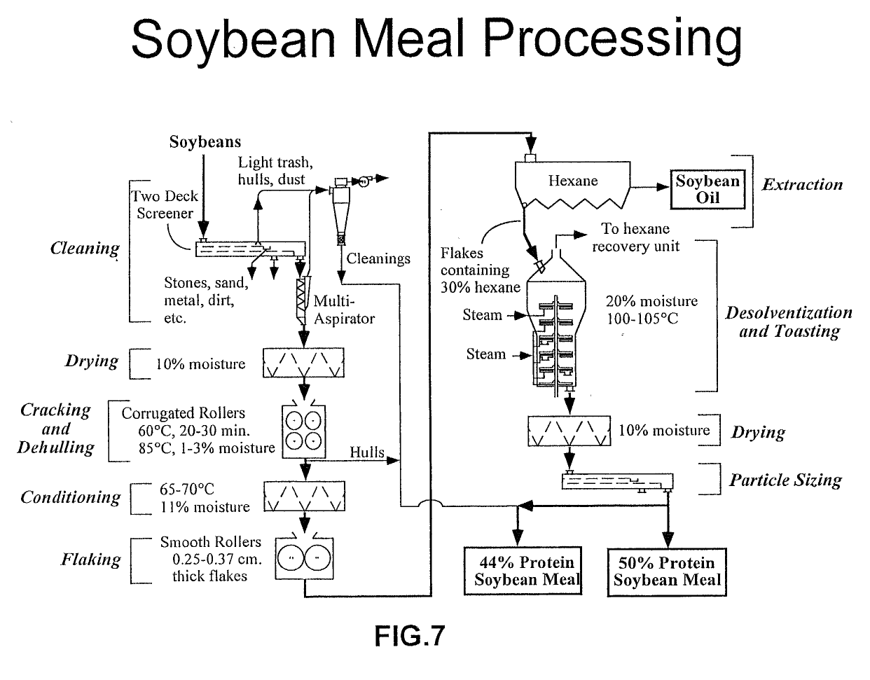

In general, “soybean meal” is defined as a high-protein residue (usually over 40% protein) that remains after the extraction of soybean oil from soybeans. A typical process for obtaining soybean meal is illustrated in FIG. 7, although embodiments of the invention are in no way limited to the process illustrated therein. Alternative methods of processing soybeans to prepare soybean meal are set forth in U.S. Pat. No. 4,103,034 to Ronai et al., the disclosure of which is incorporated herein in its entirety. Soybean meal is a common and generally preferred protein source in the preparation of animal feed, and may be solvent or expeller extracted, full or dehulled soybean meal, or processed in other methods known in the art.

“Animal feed” generally comprises a mixture of organic materials including at least one protein source such as an oilseed meal (i.e., soybean meal), at least one carbohydrate source, and other components such as filler, bulking material, added nutritive materials, and other components described further herein. Animal feeds are well known in the art and include high quality protein feeds as well as other feeds of lesser protein quality. Feeds may include soybean meal, cotton seed meal, feather meal, blood meal, silages, meat and bone meal, sunflower seed meal, canola meal, peanut meal, safflower meal, linseed meal, sesame meal, early bloom legumes, fish products, by-product protein feedstuffs like distillers and brewers grains, milk products, poultry products, hays, corn, wheat, alfalfa, barley, milo, sorghum and mixtures thereof. Other components that may be included in animal feeds are further described below.

B. Properties Of Hyperthermophilic α-Galactosidases

Isolated α-galactosidases from thermophilic organisms (also referred to herein as “hyperthermophilic enzymes” or “hyperthermophilic α-galactosidases”) are useful in the present invention. Thermophilic organisms from which isolated α-galactosidases may be isolated include species of the bacterial genuses Thermus (e.g., Thermus thermophila) and Thermotoga. Preferred hyperthermophilic organisms include species of the Thermotoga genus, including Thermotoga maritima, Thermotoga neopolitana, and Thermotoga elfii, and Thermotoga sp. T2, with Thermotoga maritima being particularly preferred. Preferred isolated α-galactosidases include those isolated from Thermotoga maritima DSM3109 and Thermotoga neopolitana 5068, and mutants or variants thereof. See, e.g., W. Liebel et al., System. Appl. Microbiol. 21, 1-11 (1998) and G. Duffaud et al., Appl. Environmental Microbiol. 63, 169-177 (1997).

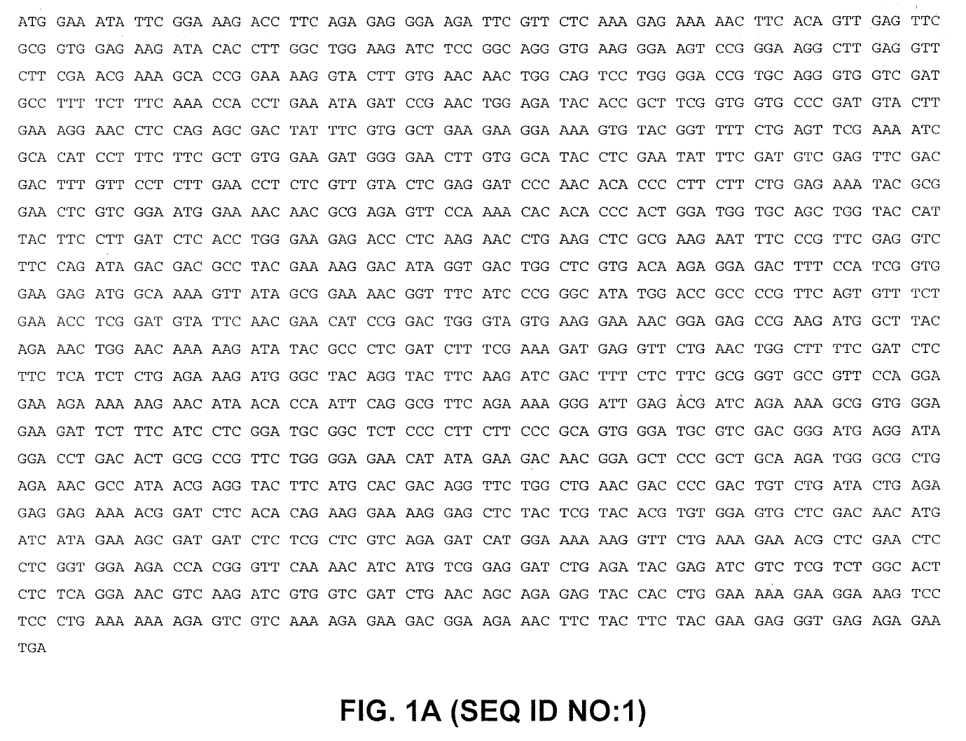

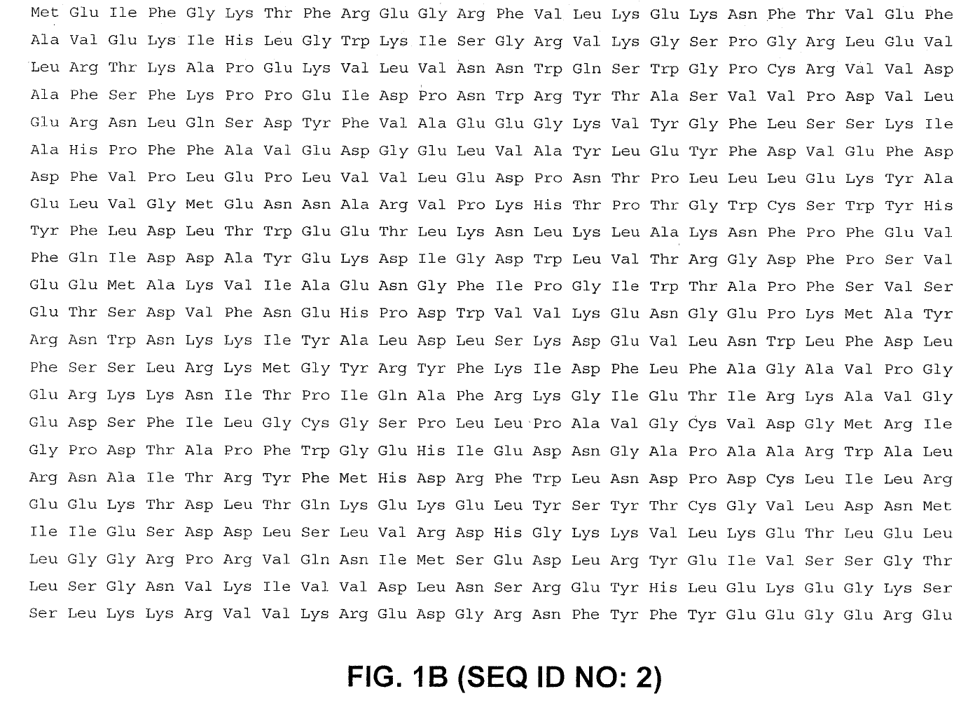

α-galactosidases may be isolated from hyperthermophilic organisms according to techniques known in the art and described herein. Descriptions of how the enzymes may be isolated from the hyperthermophilic organisms may also be found in G. Duffaud et al., Appl. Environmental Microbiol. 63, 169-177 (1997). As used in the present invention, the α-galactosidases may be natural, synthetic, semi-synthetic, or recombinant. In one preferred embodiment, the hyperthermophilic α-galactosidase of the present invention has the amino acid sequence set forth herein as SEQ ID NO: 2 (see FIG. 1). Hyperthermophilic α-galactosidase of the present invention may be encoded by an isolated polynucleotide, a preferred embodiment of which is cDNA with the nucleotide sequence set forth herein as SEQ ID NO: 1.

The enzymes of the present invention may be a naturally purified product, or a product of chemical synthetic procedures, or produced by recombinant techniques from a prokaryotic or eukaryotic host (for example, by bacterial, yeast, higher plant, insect and mammalian cells in culture), as described more completely below. Depending upon the host employed in a recombinant production procedure, the enzymes of the present invention may be glycosylated or may be non-glycosylated. Enzymes of the invention may or may not also include an initial methionine amino acid residue.

Optimal temperatures at which the enzymes of the present invention are active will vary according to each enzyme and each organism from which the enzyme was initially isolated. In general, the enzymes of the present invention are active at temperatures higher than about 75° C., more preferably higher than about 80° C., and most preferably higher than about 85° C. Enzymes of the present invention may be active at temperatures as high as 90° C. or even 100° C. In a most preferred embodiment, the enzymes of the present invention have little or no activity at normal ambient or room temperatures (i.e., at about 25° C.). In general, enzymes of the present invention will have maximum half-lives at their optimal temperatures, which will generally be between about 80° C. and 98° C., more preferably between about 85° C. and 98° C. These enzymes will generally be active at 100° C., although half lives of the enzymes at these temperatures will generally be shorter.

Hyperthermophilic α-galactosidases of the present invention are active in environments with varying and broad degrees of moisture content. For example, hyperthermophilic α-galactosidases of the present invention are active at about 70% moisture content, about 45% moisture content, at about 25% moisture content, and even lower.

Skilled artisans will recognize that useful variants of the enzymes of the present invention may be designed for optimal activity with particular substrates or conditions using “directed evolution” or metabolic engineering techniques, such as those set forth in, for example, U.S. Pat. No. 5,837,458 to Minshull et al., U.S. Pat. No. 5,837,500 to Ladner et al., and U.S. Pat. No. 5,811,238 to Stemmer et al., the disclosures of which are incorporated herein in their entirety by reference.

C. Production Of Hyperthermophilic α-Galactosidases

In one embodiment, hyperthermophilic α-galactosidases may be isolated and optionally purifed from their native hyperthermophilic organism according to techniques known in the art. An exemplary description of how naturally occurring hyperthermophilic α-galactosidases may be isolated from their native hyperthermophilic organisms and suitable conditions and reagents therefor may be found in G. Duffaud et al., Appl. Environmental Microbiol. 63, 169-177 (1997).

In another embodiment, a polynucleotide (preferably, DNA) encoding a hyperthermophilic α-galactosidase is cloned and expressed (or overexpressed) to produce an enzyme useful in the present invention. The expressed protein is then isolated and used in the methods and compounds of the present invention. The hyperthermophilic enzymes produced in this manner may then be optionally purified, although the enzymes may be used in the present methods in non-purified or partially purified form.

The polynucleotide sequence used to express the α-galactosidase may be of genomic, cDNA, or of synthetic origin, or of any combination thereof. The polynucleotide sequence can also be cloned by any general method involving: cloning, in suitable vectors, a cDNA library from any hyperthermophilic α-galactosidase-producing strain; transforming suitable host cells with said vectors; culturing the host cells under suitable conditions to express the enzyme encoded by a clone in the cDNA library; screening for positive clones by determining any hyperthermophilic α-galactosidase activity of the enzyme produced by such clones; and isolating the enzyme-encoding DNA from such clones.

The polynucleotide used to express the α-galactosidase may, in accordance with well-known procedures, conveniently be cloned from any hyperthermophilic α-galactosidase-producing organism by hybridization using a synthetic oligonucleotide probe prepared on the basis of the DNA sequence presented as SEQ ID NO: 1 (see FIG. 1A), or any suitable subsequence thereof, or on the basis of the amino acid sequence presented as SEQ ID NO: 2 (see FIG. 1B). Alternatively, the DNA sequences may be cloned by use of PCR primers prepared on the basis of the DNA sequences disclosed herein.

As noted above, the present invention utilizes isolated and optionally purified hyperthermophilic α-galactosidase. Such proteins can be isolated from host cells which express the same, in accordance with known techniques, or even manufactured synthetically. Nucleic acids of the present invention, constructs containing the same and host cells that express the encoded proteins are useful for making enzymes of the present invention.

Specific initiation signals may also be used to achieve more efficient translation of sequences encoding hyperthermophilic α-galactosidase. Such signals include the initiation codon and adjacent sequences. In cases where sequences encoding hyperthermophilic α-galactosidase, its initiation codon, and upstream sequences are inserted into the appropriate expression vector, no additional transcriptional or translational control signals may be needed. However, in cases where only coding sequence, or a fragment thereof, is inserted, exogenous translational control signals including the initiation codon should be provided. Furthermore, the initiation codon should be in the correct reading frame to ensure translation of the entire insert. Exogenous translational elements and initiation codons may be of various origins, both natural and synthetic. The efficiency of expression may be enhanced by the inclusion of enhancers which are appropriate for the particular cell system which is used, such as those described in the literature. See e.g., D. Scharf et al., Results Probl. Cell Differ. 20, 125-162 (1994).

Polynucleotides encoding hyperthermophilic α-galactosidases of the present invention include those coding for proteins homologous to, and having essentially the same biological properties as, the proteins disclosed herein, and particularly the DNA disclosed herein as SEQ ID NO: 1 and encoding the hyperthermophilic α-galactosidase provided herein as SEQ ID NO: 2. This definition is intended to encompass natural allelic sequences thereof. Thus, polynucleotides that hybridize to DNA disclosed herein as SEQ ID NO: 1 (or fragments or derivatives thereof which serve as hybridization probes as discussed below) and which code on expression for a protein of the present invention (e.g., a protein according to SEQ ID NO: 2), are also useful in the practice of the invention.

Conditions which will permit other polynucleotides that code on expression for a protein of the present invention to hybridize to the DNA of SEQ ID NO: 1 disclosed herein can be determined in accordance with known techniques. For example, hybridization of such sequences may be carried out under conditions of reduced stringency, medium stringency or even stringent conditions (e.g., conditions represented by a wash stringency of 35-40% formamide with 5×Denhardt's solution, 0.5% SDS and 1×SSPE at 37° C.; conditions represented by a wash stringency of 40-45% formamide with 5×Denhardt's solution, 0.5% SDS, and 1×SSPE at 42° C.; and conditions represented by a wash stringency of 50% formamide with 5×Denhardt's solution, 0.5% SDS and 1×SSPE at 42° C., respectively) to DNA of SEQ ID NO: 1 disclosed herein in a standard hybridization assay. In general, sequences which code for proteins of the present invention and which hybridize to the DNA of SEQ ID NO: 1 disclosed herein will be at least 75% homologous, 85% homologous, and even 95% homologous or more with SEQ ID NO: 1, respectively. Further, polynucleotides that code for proteins of the present invention, or polynucleotides that hybridize to that as SEQ ID NO: 1, but which differ in codon sequence from SEQ ID NO: 1 due to the degeneracy of the genetic code, are also useful in the practice of this invention. The degeneracy of the genetic code, which allows different nucleic acid sequences to code for the same protein or peptide, is well known in the literature. See, e.g., U.S. Pat. No. 4,757,006 to Toole et al. at Col. 2, Table 1.

Although nucleotide sequences which encode hyperthermophilic α-galactosidase and its variants are preferably capable of hybridizing to the nucleotide sequence of the naturally occurring hyperthermophilic α-galactosidase under appropriately selected conditions of stringency, it may be advantageous to produce hyperthermophilic α-galactosidase or its derivatives possessing a substantially different codon usage. Codons may be selected to increase the rate at which expression of the peptide occurs in a particular prokaryotic or eukaryotic host in accordance with the frequency with which particular codons are utilized by the host. Other reasons for substantially altering the nucleotide sequence encoding hyperthermophilic α-galactosidase and its derivatives without altering the encoded amino acid sequences include the production of RNA transcripts having more desirable properties, such as a greater half-life, than transcripts produced from the naturally occurring sequence.

The invention also encompasses production of DNA sequences, or fragments thereof, which encode hyperthermophilic α-galactosidase and its derivatives, entirely by synthetic chemistry. After production, the synthetic sequence may be inserted into any of the many available expression vectors and cell systems using reagents that are well known in the art. Moreover, synthetic chemistry may be used to introduce mutations into a sequence encoding hyperthermophilic α-galactosidase or any fragment thereof.

The nucleotide sequence as disclosed herein in SEQ ID NO: 1 can be used to generate hybridization probes which specifically bind to the polynucleotide (i.e., cDNA) of the present invention or to mRNA to determine the presence of amplification or overexpression of the proteins of the present invention.

The production of cloned genes, recombinant DNA, vectors, transformed host cells, proteins and protein fragments by genetic engineering is well known. See, e.g., U.S. Pat. No. 4,761,371 to Bell et al. at Col. 6 line 3 to Col. 9 line 65; U.S. Pat. No. 4,877,729 to Clark et al. at Col. 4 line 38 to Col. 7 line 6; U.S. Pat. No. 4,912,038 to Schilling at Col. 3 line 26 to Col. 14 line 12; and U.S. Pat. No. 4,879,224 to Wallner at Col. 6 line 8 to Col. 8 line 59. (Applicant specifically intends that the disclosure of all patent references cited herein be incorporated herein in their entirety by reference).

A vector is a replicable nucleic acid (preferably, DNA) construct. Vectors may be used herein either to amplify DNA encoding the proteins of the present invention or to express the proteins of the present invention. An expression vector is a replicable nucleic acid construct in which a nucleic acid sequence encoding the enzymes of the present invention is operably linked to suitable control sequences capable of effecting the expression of enzymes of the present invention in a suitable host. The need for such control sequences will vary depending upon the host selected and the transformation method chosen. Generally, control sequences include a transcriptional promoter, an optional operator sequence to control transcription, a sequence encoding suitable mRNA ribosomal binding sites, and sequences which control the termination of transcription and translation. Amplification vectors do not require expression control domains. All that is needed is the ability to replicate in a host, usually conferred by an origin of replication, and a selection gene to facilitate recognition of transformants.

Vectors include but are not limited to plasmids, cosmids, viruses (e.g., adenovirus, cytomegalovirus), phage, retroviruses, artificial chromosomes and integratable DNA fragments (i.e., fragments integratable into the host genome by recombination). The vector replicates and functions independently of the host genome, or may, in some instances, integrate into the genome itself. Expression vectors preferably contain a promoter and RNA binding sites which are operably linked to the gene to be expressed and are operable in the host organism.

Nucleic acid regions are operably linked or operably associated when they are functionally related to each other. For example, a promoter is operably linked to a coding sequence if it controls the transcription of the sequence; a ribosome binding site is operably linked to a coding sequence if it is positioned so as to permit translation. Generally, operably linked means contiguous and, in the case of leader sequences, contiguous and in reading phase.

Transformed host cells are cells which have been transformed or transfected with vectors containing polynucleotides coding for hyperthermophilic α-galactosidase of the present invention need not, but preferably do, express hyperthermophilic α-galactosidase. Suitable host cells include prokaryotes, yeast cells, or higher eukaryotic organism cells.

Prokaryote host cells include gram negative or gram positive organisms, for example Escherichia coli (E. Coli) or Bacilli, with E. Coli being preferred. E. Coli is typically transformed using plasmids initially derived from pBR322. See Bolivar et al., Gene 2, 95 (1977) or vectors derived therefrom.

Expression vectors preferably contain a promoter which is recognized by the host organism. This generally, although not necessarily, means a promoter obtained from the intended host. The promoter and Shine-Dalgarno sequence (for prokaryotic host expression) are operably linked to the DNA of the present invention, i.e., they are positioned so as to promote transcription of the messenger RNA from the DNA. In the present invention, preferred promoters include the known λ_{pL}, T₇, and Pₘ promoters. Other promoters commonly used in recombinant microbial expression vectors include the beta-lactamase (penicillinase) and lactose promoter systems (Chang et al., Nature 275, 615 (1978); and Goeddel et al., Nature 281, 544 (1979); a tryptophan (trp) promoter system (Goeddel et al., Nucleic Acids Res. 8, 4057 (1980) and EPO App. Publ. No. 36,776); and the tac promoter (H. De Boer et al., Proc. Natl. Acad. Sci. USA 80, 21 (1983). While the foregoing are commonly used, other microbial promoters are suitable. Details concerning nucleotide sequences of many have been published, enabling a skilled worker to operably ligate them to DNA encoding the protein in plasmid or viral vectors (Siebenlist et al., Cell 20, 269 (1980).

Eukaryotic microbes such as yeast cultures may also be transformed with suitable hyperthermophilic α-galactosidase encoding vectors. See e.g., U.S. Pat. No. 4,745,057. Saccharomyces cerevisiae is the most commonly used among lower eukaryotic host microorganisms, although a number of other strains are commonly available. Yeast vectors may contain an origin of replication from the 2 micron yeast plasmid or an autonomously replicating sequence (ARS), a promoter, DNA encoding the desired protein, sequences for polyadenylation and transcription termination, and a selection gene. An exemplary plasmid is YRp7, (Stinchcomb et al., Nature 282, 39 (1979); Kingsman et al., Gene 7, 141 (1979); Tschemper et al., Gene 10, 157 (1980)). This plasmid contains the trp1 gene, which provides a selection marker for a mutant strain of yeast lacking the ability to grow in tryptophan, for example ATCC No. 44076 or PEP4-1 (Jones, Genetics 85, 12 (1977). The presence of the trp1 lesion in the yeast host cell genome then provides an effective environment for detecting transformation by growth in the absence of tryptophan.

Suitable promoting sequences in yeast vectors include the promoters for metallothionein, 3-phospho-glycerate kinase (Hitzeman et al., J. Biol. Chem. 255, 2073 (1980) or other glycolytic enzymes (Hess et al., J. Adv. Enzyme Reg. 7, 149 (1968); and Holland et al., Biochemistry 17, 4900 (1978), such as enolase, glyceraldehyde-3-phosphate dehydrogenase, hexokinase, pyruvate decarboxylase, phosphofructokinase, glucose-6-phosphate isomerase, 3-phosphoglycerate mutase, pyruvate kinase, triosephosphate isomerase, phosphoglucose isomerase, and glucokinase. Suitable vectors and promoters for use in yeast expression are further described in R. Hitzeman et al., EPO Publn. No. 73,657.

Cultures of cells derived from multi-cellular organisms may also be used for recombinant protein synthesis. In principal, any higher eukaryotic cell culture is workable, whether from vertebrate or invertebrate culture, including insect cells. Propagation of such cells in cell culture has become a routine procedure. See Tissue Culture (Academic Press, Kruse and Patterson, eds.) (1973). Expression vectors for such cells ordinarily include (if necessary) an origin of replication, a promoter located upstream from the gene to be expressed, along with a ribosome binding site, RNA splice site (if intron-containing genomic DNA is used), a polyadenylation site, and a transcriptional termination sequence.

Host cells such as insect cells (e.g., cultured Spodoptera frugiperda cells) and expression vectors such as the baculorivus expression vector may also be employed to make proteins useful in carrying out the present invention, as described in U.S. Pat. Nos. 4,745,051 and 4,879,236 to Smith et al. In general, a baculovirus expression vector comprises a baculovirus genome containing the gene to be expressed inserted into the polyhedrin gene at a position ranging from the polyhedrin transcriptional start signal to the ATG start site and under the transcriptional control of a baculovirus polyhedrin promoter.

In addition, a host cell strain may be chosen for its ability to modulate the expression of the inserted sequences or to process the expressed protein in the desired fashion. Such modifications of the polypeptide include, but are not limited to, acetylation, carboxylation, glycosylation, phosphorylation, lipidation, and acylation. Post-translational processing which cleaves a “prepro” form of the protein may also be used to facilitate correct insertion, folding and/or function. Different host cells which have specific cellular machinery and characteristic mechanisms for post-translational activities (e.g., CHO, HeLa, MDCK, HEK293, and WI38), are available from the American Type Culture Collection (ATCC; Bethesda, Md.) and may be chosen to ensure the correct modification and processing of the foreign protein.

For long-term, high-yield production of recombinant proteins, stable expression is preferred. For example, cell lines which stably express hyperthermophilic α-galactosidase may be transformed using expression vectors which may contain viral origins of replication and/or endogenous expression elements and a selectable marker gene on the same or on a separate vector. Following the introduction of the vector, cells may be allowed to grow for 1-2 days in an enriched media before they are switched to selective media. The purpose of the selectable marker is to confer resistance to selection, and its presence allows growth and recovery of cells which successfully express the introduced sequences. Resistant clones of stably transformed cells may be proliferated using tissue culture techniques appropriate to the cell type.

Host cells transformed with nucleotide sequences encoding hyperthermophilic α-galactosidase may be cultured under conditions suitable for the expression and recovery of the protein from cell culture. The enzyme produced by a transformed cell may be secreted or contained intracellularly depending on the sequence and/or the vector used. As will be understood by those of skill in the art, expression vectors containing polynucleotides which encode hyperthermophilic α-galactosidase may be designed to contain signal sequences which direct secretion of hyperthermophilic α-galactosidase through a prokaryotic or eukaryotic cell membrane. Other constructions may be used to join sequences encoding hyperthermophilic α-galactosidase to nucleotide sequence encoding a polypeptide domain which will facilitate purification of soluble proteins.

The enzyme can be recovered and purified from recombinant cell cultures by methods including ammonium sulfate or ethanol precipitation, acid extraction, anion or cation exchange chromatography, phosphocellulose chromatography, hydrophobic interaction chromatography, affinity chromatography, hydroxylapatite chromatography and lectin chromatography. Protein refolding steps can be used, as necessary, in completing configuration of the mature protein. Finally, high performance liquid chromatography (HPLC) can be employed for final purification steps.

In general, those skilled in the art will appreciate that minor deletions or substitutions may be made to the amino acid sequences of peptides of the present invention without unduly adversely affecting the activity thereof. Thus, peptides containing such deletions or substitutions are a further aspect of the present invention. In peptides containing substitutions or replacements of amino acids, one or more amino acids of a peptide sequence may be replaced by one or more other amino acids wherein such replacement does not affect the function of that sequence. Such changes can be guided by known similarities between amino acids in physical features such as charge density, hydrophobicity/hydrophilicity, size and configuration, so that amino acids are substituted with other amino acids having essentially the same functional properties. For example: Ala may be replaced with Val or Ser; Val may be replaced with Ala, Leu, Met, or Ile, preferably Ala or Leu; Leu may be replaced with Ala, Val or Ile, preferably Val or lie; Gly may be replaced with Pro or Cys, preferably Pro; Pro may be replaced with Gly, Cys, Ser, or Met, preferably Gly, Cys, or Ser; Cys may be replaced with Gly, Pro, Ser, or Met, preferably Pro or Met; Met may be replaced with Pro or Cys, preferably Cys; His may be replaced with Phe or Gln, preferably Phe; Phe may be replaced with His, Tyr, or Trp, preferably His or Tyr; Tyr may be replaced with His, Phe or Trp, preferably Phe or Trp; Trp may be replaced with Phe or Tyr, preferably Tyr; Asn may be replaced with Gln or Ser, preferably Gln; Gln may be replaced with His, Lys, Glu, Asn, or Ser, preferably Asn or Ser; Ser may be replaced with Gln, Thr, Pro, Cys or Ala; Thr may be replaced with Gln or Ser, preferably Ser; Lys may be replaced with Gln or Arg; Arg may be replaced with Lys, Asp or Glu, preferably Lys or Asp; Asp may be replaced with Lys, Arg, or Glu, preferably Arg or Glu; and Glu may be replaced with Arg or Asp, preferably Asp. Once made, changes can be routinely screened to determine their effects on function with enzymes.

In addition to recombinant production, fragments of hyperthermophilic α-galactosidase may be produced by direct peptide synthesis using solid-phase techniques (J. Merrifield, J. Am. Chem. Soc. 85, 2149-2154 (1963)). Protein synthesis may be performed using manual techniques or by automation. Automated synthesis may be achieved, for example, using Applied Biosystems 431A Peptide Synthesizer (Perkin Elmer). Various fragments of hyperthermophilic α-galactosidases may be chemically synthesized separately and combined using chemical methods to produce the full length molecule.

D. Methods And Compositions Utilizing Hyperthermophilic α-Galactosidases

The isolated α-galactosidases are useful in the hydrolysis of galactose-containing oligosaccharides and compounds, substrates and complex mixtures comprising the same. Oligosaccharides hydrolyzed by the α-galactosidases of the present invention include but are not limited to raffinose, stachyose, verbascose, and PNP-galactose.

In a preferred embodiment, the α-galactosidases of the present invention are useful in the preparation of animal feed. Animals include mammals, avians, fish and reptiles, with mammals and avians being particularly preferred. When animals are mammals, livestock is preferred, including cows, pigs, horses and goats. When animals are avians, preferred animals are chickens and turkeys. When animals are fish, preferred animals are catfish.

Animal feed (e.g., chicken and other poultry feed, feed for livestock, domestic animal feed) is generally prepared by mixing different ingredients or components which are found to be necessary (i.e., “active ingredients”) with carrier materials essential to provide the feed in the desired form. The feed or feed ingredient may be any ingredient that is needed, preferably including protein and carbohydrate sources. The choice of active ingredients may depend on the nutritional value or on certain characteristics which may be obtained by the activity of the ingredient. Enzymes or proteins, amino acid, pigments, vitamins, antioxidants, antibiotics, coloring agents and carotenoids may also be added to the feed. Obviously, combinations of these ingredients can be added, simultaneously or successively.

The protein component of animal feed is preferably in the form of a protein meal (i.e., soybean meal) of some kind. Suitable forms of protein meals are described in detail above. Other exemplary sources of protein include single cell proteins or hydrolysates of proteins such as those from yeast, algae or bacteria; isolated animal proteins, peptides or hydrolysates of proteins such as hemoglobin, myosin, plasma, or other serum proteins, collagen, casein, albumin or keratin; complex protein sources or hydrolysates of proteins such as milk, blood, whey, blood meal, meatmeal, feathermeal, fishmeal, meat and bone meal, poultry offal, poultry by-product meal, hatchery by-products, egg offal, egg white, egg yolk, and eggs without shells; plant protein or hydrolysate of proteins such as isolated soybean protein, wheat protein, wheat germ, distillers grains and gluten. In a preferred embodiment of the invention, the protein source of the animal feed is a vegetable protein source, and in a more preferred embodiment is soybean, in any of the usable forms of soybean, including soy meal, soy flakes, soy grits and the like.

Carbohydrates included in animal feed provide a source of nutrition for the animals and, in addition, can aid in the formation of the solid feed. Useful carbohydrates include corn starch, potato starch, wheat starch, rice starch, cellulose, pectin, agarose, and gums; bioavailable sugars such as glucose, fructose, and sucrose; chemically modified starches such as modified corn starch, methylcellulose, carboxymethylcellulose, and dextrin; humectants such as glycerol or propylene glycol; invert sugar; and ground complex carbohydrates such as corn, rice, oats, barley, wheat, sorghum, rye, millet, cassava, triticale and tapioca, in whole, ground, cracked, milled, rolled, extruded, pelleted, defatted, dehydrated, solvent extracted or other processed form.

The animal feed may and preferably does contain moisture (i.e., water) along with the combination of ingredients In one embodiment, the animal feed may be formed from a colloidal solution containing a gum dissolved in water. Gums which may be used for this purpose are generally high molecular weight molecules of plant or animal origin, usually with colloidal properties, which in appropriate solvents are able to produce gels, such as agar, algin and carrageenan derived from seaweeds, plant exudates such as gum arabic, ghatti and tragacanth, plant extracts such as pectin, plant seeds such as guar, locust bean, and animal exudates such as plasma, serum albumin, egg albumin, chitin and gelatin. Other gums include amylose and amylopectin and gums of bacterial origin.

The animal feed is preferably stabilized against microbial growth. That is, if treated properly, upon being sealed and stored at room temperature for an extended period of at least about eight weeks the animal feed will show no indication of microbial growth. The feed may be stabilized, for example, by sterilizing, adding a microbial growth inhibitor such as methyl paraben or a sorbate thereto, or adjusting the pH of the mixture from which the feed is formed.

To increase its nutritional value for some applications such as longer-term feeding, the feed preferably comprises an amino acid source such as protein(s), amino acids, precursors or analogues of amino acids, and mixtures thereof. Exemplary amino acids are essential amino acids such as methionine, tryptophan, threonine, arginine and lysine. Exemplary amino acid precursors are 2-hydroxy-4-(methylthio)butanoic acid sold, for example, under the trademark ALIMET® by Novus International (St. Louis, Mo.), and salts of 2-hydroxy-4-(methylthio)butanoic acid such as the calcium and sodium salts.

Although not preferred for certain applications, fats or lipids may also be included in the feed in relatively small proportions. Suitable fats include fatty acids such as linoleic acid; isolated plant oils such as sunflower, safflower, soybean, peanut, canola, corn, rapeseed, olive, linseed and palm; fat meals such as cottonseed, peanut, rapeseed, palm meal and nut meals; and fats of animal origin such as egg yolk, lard, butter, poultry fat, tallow and fish oil.

The animal feed may additionally contain vitamins and minerals. Vitamin additives may be selected, for example, from vitamin A, B₁₂, biotin, choline, folacin, niacin, pantothenic acid, pyridoxine, riboflavin, thiamin, C, D, 25-hydroxy D, E, and K. Mineral additives may be selected, for example, from calcium, phosphorous, selenium, chlorine, magnesium, potassium, sodium, copper, iodine, iron, manganese and chromium piccolinate.

The animal feed may also comprise other, non-α-galactosidase enzymes such as hydrolases that target other classes of compounds such as proteins, non-starch polysaccharides, lipids etc. A more complete list of enzymes, hormones, antibiotics, colorizers, stabilizers, amino acid sources and enzymes that may be used in the present invention are set forth in U.S. Pat. No. 5,985,336 to Ivey et al., the disclosure of which is incorporated herein by reference in its entirety.

As illustrated in FIG. 7 and as described above, the processing of components of animal feed (e.g., soy meal) and animal feed itself may involve several steps that are carried out at high temperatures (i.e., over 60° C., over 70° C. or even over 80° C.). In particular, components of animal feed may be exposed to steam treatments during processing in order to, for example, remove solvent or “cook” the meal to obtain certain nutritive characteristics. Generally, processing of the animal feed concludes with an extrusion or forming process in which the feed is formed into pellets or other desirable forms for animal consumption. The desired form may be a powder, a pellet, a solution or a suspension. The preferred form will depend on the application conditions, the composition and the method of transport to the final user destination.

In the present invention, the hyperthermophilic α-galactosidase described herein may be added to the animal feed at any point in feed or meal processing following removal of hulls, shells or skins from, for example, soybeans, other beans, legumes, corn, wheat, oat, beet, canola, rice or other grains or protein sources, up to and including pelleting or extrusion of the animal feed. For example, the hyperthermophilic α-galactosidase may be added when the various ingredients of the feed are being combined. The only limitation on what point in the feed processing the hyperthermophilic α-galactosidase may be added is that the enzyme must be added prior to a processing step carried out under high temperature (i.e., higher than about 60° C., 70° C., 75° C. or 80° C.) conditions. Preferably, the hyperthermophilic α-galactosidase is added prior to any steam treatment that the components of animal feed or animal feed may undergo during processing.

The hyperthermophilic α-galactosidase may be added to the components of animal feed or animal feed in any suitable form, including liquid form (i.e., the enzyme is in solution or in culture) or dry powder. If added in dried form, the hyperthermophilic α-galactosidase may be spray dried, lyophilized, freeze dried or dried by any other suitable process known in the art. The hyperthermophilic α-galactosidase may be added in a crude form, a partially purified form, a substantially purified form, or a purified form.

The addition of the hyperthermophilic α-galactosidase during processing of the feed provides certain advantages over the prior art. The hyperthermophilic α-galactosidases are active at the high temperatures that are used in animal feed processing, thus eliminating the need to apply enzymes after the pelleting or extrusion process. After treatment with the hyperthermophilic α-galactosidase, the animal feed retains galactose and sucrose monomers as a usable and digestible energy source for the animal. Since anti-nutritive factors (i.e., indigestible oligosaccharides) are removed by the enzyme, the energy value increases because of increased galactose and sucrose availability, and does the utilization of protein. Finally, the enzyme is active prior to digestion of the meal by the animal, thus guaranteeing that any nutritive advantage provided by the breakdown of oligosaccharides is realized by the animal.

In another embodiment of the invention, the hyperthermophilic α-galactosidase is used as a food additive for human food. The advantage of using the hyperthermophilic α-galactosidases of the present invention resides in the high temperature activity of the enzymes. That is, the enzyme can be added to food prior to preparation such as cooking, because the increased temperature applied to the food by cooking or heating activates the enzyme. In this embodiment, the hyperthermophilic α-galactosidase is either incorporated into the food prior to packaging of the food (e.g., in soy milk that is to be heated), or onto food prior to cooking. The activity of the hyperthermophilic α-galactosidase of breaking down indigestible oligosaccharides thus acts to decrease gastrointestinal distress, as described above.

When used as a food additive, the hyperthermophilic α-galactosidase may be used in any of several forms, including liquid or powder. A powdered form of the enzyme may be packaged or kept in a “salt-shaker” or other kind of powder dispenser, which powder can be sprinkled on the food prior to cooking. In powdered form, the hyperthermophilic α-galactosidase may be combined with one or more excipients, which may also be in powdered or dried form. Representative examples of dry ingredients that can be combined with a food grade α-galactosidase include but are not limited to: dextrose, dicalcium phosphate, microcrystalline cellulose, modified cellulose and modified starch. These excipients are available from known trade sources. Criteria for selecting these excipients, besides their function as ingestible non-toxic carriers of the α-galactosidase, are their palatability and ease of flow.

In a liquid form, the enzyme may be added to food from a bottle, can, or other container. Concentrated (highly pure) liquid α-galactosidase may be formed into by dissolving or mixing a dried or powdered form of the enzyme with a solvent such as water. The liquid form of the enzyme may be diluted with other appropriate diluent liquids or excipients. The degree of dilution will depend on the use intended. Representative examples of liquid excipients include, but are not limited to, water, glycerol and sorbitol. Criteria for choosing proper liquid excipients may include miscibility, stabilization qualities and taste.

In still another embodiment of the invention, the hyperthermophilic α-galactosidase may be used as a processing additive useful in the production of an edible, vegetable protein product (also referred to herein interchangeably as an edible protein isolate or and edible protein concentrate), such as an edible soy protein product Specifically, the hyperthermophilic α-galactosidase of the present invention may aid in the process of removing unwanted oligosaccharides and galactose monomers from the protein product, thus allowing the production of vegetable protein products that are partially, substantially or completely lacking in galactose or oligosaccharide components.

Methods of preparing isolated soy proteins and other vegetable proteins are known. See, e.g., U.S. Pat. No. 5,936,069 to Johnson et al., and the website www.centralsoya.com. Removal of oligosaccharides and carbohydrates from the isolated protein product is sometimes desirable for nutritive reasons. Present methods of removing oligosaccharides from protein isolates are often time-consuming, expensive and difficult.

Using the processing of isolated soy proteins as an example, in the method of the present invention the hyperthermophilic α-galactosidase is added to a soy substrate (for example, a soy flake mixture) during the processing of the edible soy protein. The mixture containing the soy substrate and hyperthermophilic α-galactosidase is then heated to a temperature at which the hyperthermophilic α-galactosidase is active, as set forth above, and for a length of time sufficient to hydrolyze the oligosaccharides in the soy mixture. The addition of the hyperthermophilic α-galactosidase may occur either before or after removal of oil from the soybean substrate, but preferably occurs prior to the extraction or further fractionation of the soy protein in its isolated form. Once hydrolyzed, the oligosaccharides may be removed from the isolated soy protein by methods that are known in the art, such as by washing the protein with water or aqueous alcohol, or by isoelectric leaching. Thus, edible vegetable protein products derived from soy processing that are either partially or completely lacking in galactose-containing oligosaccharides may be produced. In this manner, gastrointestinal distress as described above may be reduced or prevented in the consumer of the isolated soy protein, in that the undesirable oligosaccharides have been removed therefrom.

The following Examples are provided to illustrate the present invention, and should not be construed as limiting thereof.

### EXAMPLE 1

### Tm galA Cloning and Expression

Tm galA was cloned by PCR from a genomic preparation of Tm total DNA. After 35 cycles, a single PCR product of approximately 1.65 kb in length was obtained. Restriction mapping using restriction enzymes BamHI, XhoI, NdeI, KpnI, and HindIII produced correct banding patterns and DNA fragments of correct size when compared to restriction maps generated from published DNA sequence. FIG. 1 shows the Tm galA nucleotide sequence published in the GenBank database (accession number 2660640, SEQ ID NO: 1). This sequence was used to generate PCR primers used in the cloning of this gene.

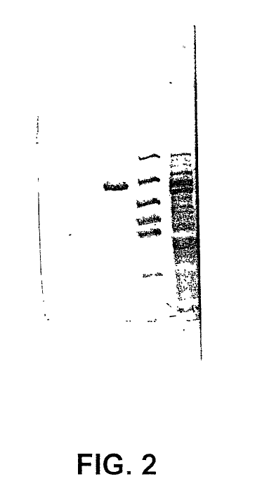

Tm galA was expressed in E. coli BL21 (λDE3) using pET24d+ as the expression vector (Novagen, Inc., Madison, Wis., USA; Stratagene, Inc., La Jolla, Calif., USA). From 4 L of culture approximately 330 units of soluble Tm GalA activity was recovered following heat treatment (80° C., 30 minutes) of French Pressed cell extracts (1 unit of enzyme activity is defined as the amount of enzyme necessary to liberate 1 μmol of PNP from PNP-galactose per minute). A single protein band of approximately 64 kDa was clearly identifiable on 12% SDS-PAGE gels, as is visible in FIG. 2. This band corresponds to the single monomer of Tm GalA as has been previously shown in W. Liebl et al., System. Appl. Microbiol. 21, 1-11 (1998).

### EXAMPLE 2

### Tm GalA Activity

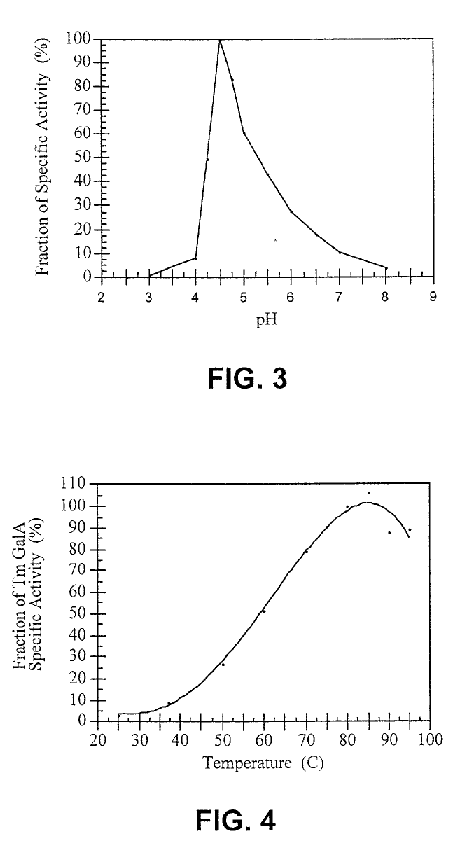

Temperature and pH optima were determined using PNP-galactose as substrate in an end point assay measuring the release of liberated PNP at 405 nm after 10 minutes. Briefly, in 1 mL the assay contained 1 mM PNP-galactose and suitably diluted enzyme in 50 mM Na acetate buffer containing 1 mM NaCl. After 10 minutes the reaction was stopped by addition of 100 μL of 1 M Na₂CO₃ and placing the reaction mixture on ice. FIG. 3 and FIG. 4 show the percent activity of the enzyme as a function of pH and temperature, respectively. From these figures it appears that the reaction optima are around a pH of 4.5 and temperature of 85° C.

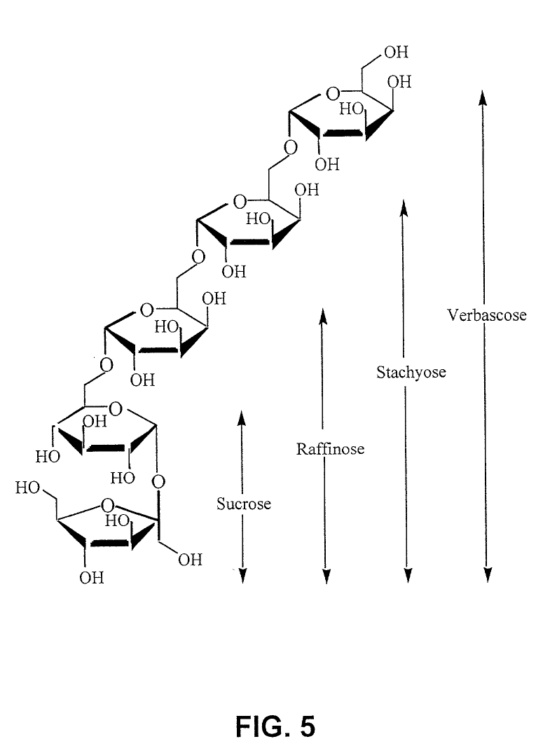

As shown in Table 1, Tm GalA activity decreases as the substrate degree of polymerization (DP) increases. Maximum Tm GalA activity was achieved using PNP-galactose as substrate, which then decreased roughly 2.5-fold with raffinose (DP3), and then 20-fold with stachyose (DP4) and verbascose (DP5). FIG. 5 provides a structural diagram of the substrates discussed. It is anticipated that a further reduction in specific activity would be observed in going from stachyose to verbascose. However, within the error of the assay technique employed (the Somogyi-Nelson technique), this observation is not seen. The Somogyi-Nelson technique assays for the production of total reducible sugars. Thus, no distinction is made between galactose liberated from verbascose or from stachyose, the product of galactose removal from verbascose.

TABLE 1
Tm GalA Specific Activity

| | Specific Activity |
|---|---|
| Substrate | (μmol min.⁻¹ mg protein⁻¹) |
| PNP-galactose | 32.5 ± 1.6 |
| Raffinose | 12.79 ± 1.31 |
| Stachyose | 0.55 ± 0.19 |
| Verbascose | 0.44 ± 0.16 |

### EXAMPLE 3

### Tm GalA Digestion of Chicken Feed

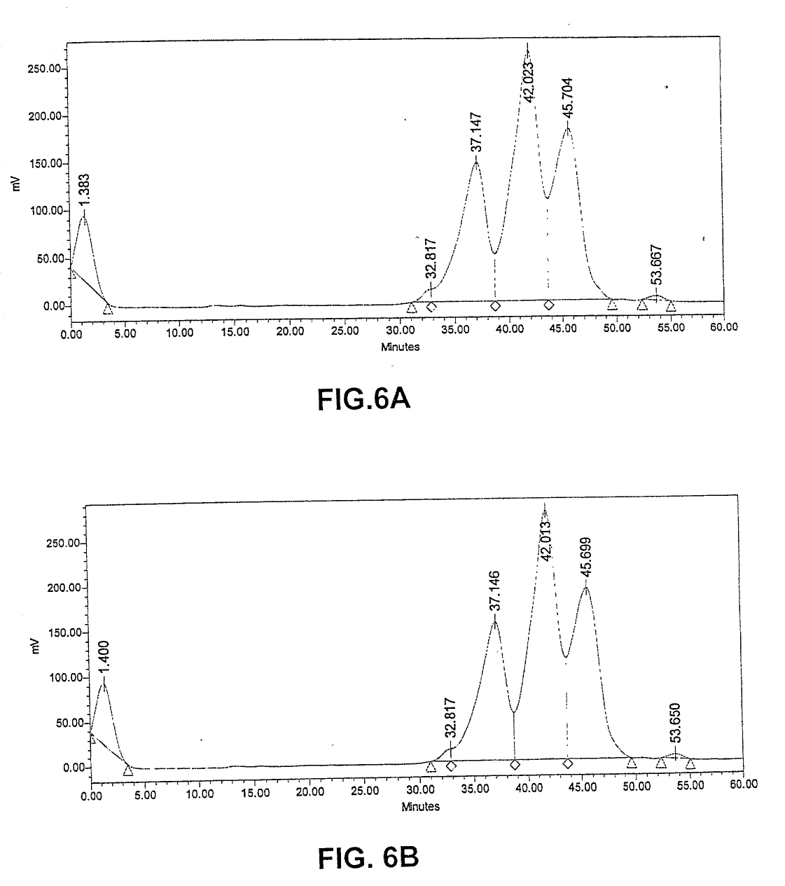

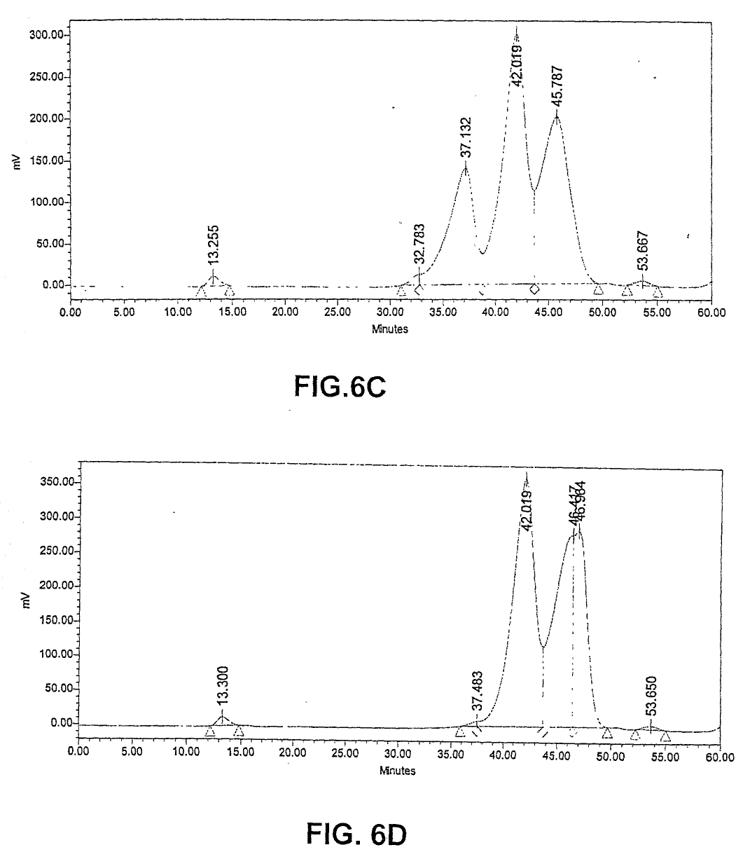

A positive effect of Tm GalA digestion on soluble chicken feed composition has been shown in both direct enzymatic treatment of the feed and on treatment of re-solubilized, ethanol extracted components. Ethanol extraction provides a means of doing a more detailed analysis of Tm GalA digestion of chicken feed components by pulling out the water soluble carbohydrate fraction of the feed from the feed matrix. Carbohydrates extracted by this technique are generally limited to DP <8.25 g of feed was extracted with 250 mL of boiling 80% ethanol under complete reflux for 2 hours. Upon evaporation of the ethanol, an orange-colored residue remained. This residue could be partially solubilized in 10 volumes of water (w/v) after mixing for 5 minutes and heating at 85° C. for 30 minutes. HPLC analysis of the soluble fraction revealed three distinct peaks at approximately 37, 42, and 46 minutes. Peaks appearing at approximately 37 and 42 minutes could be putatively identified as stachyose and sucrose, respectively, based on retention time in comparison with known standards (see FIGS. 6). FIGS. 6A-6D provide a comparison of HPLC chromatograms of undigested and Tm GalA soluble composition results. After treating the soluble fraction for one hour with 15 units of Tm GalA the complete disappearance of the ‘stachyose’ peak can be observed, as illustrated in FIG. 6D. The initial stachyose concentration in this particular experiment is estimated at approximately 5.6 mM. In addition, to the disappearance of stachyose, the appearance of a galactose peak at approximately 47 minutes can be observed as well as a concomitant increase in the sucrose peak from 4.77×10⁷ area counts at t=0 to 5.44×10⁷ area counts one hour later. FIGS. 6A and 6B show the results of the non-enzymatic controls for comparison.

Direct treatment of the feed (100 mg ml⁻¹) with 50 units of Tm GalA produced similar results as that for digestion of the extracted soluble fraction. In these experiments, the feed was preheated at 98° C. for 2 hours prior to addition of the enzyme. As with the previous study, within the first hour the complete disappearance of the stachyose peak in the HPLC chromatogram can be observed with a concomitant appearance of a galactose peak.

### EXAMPLE 4

### Effect of Temperature and Moisture Content On TmGalA Digestion of Soy Meal and Soy Flake

The effect of temperature on direct TmGalA digestion of soy meal and soy flake is illustrated in Table 2. Experiments were conducted with 4 grams of soy meal or soy flake, 50 U of α-Gal/500 mg of meal or flake, and 70% moisture level. The soy meal/flake-α-Gal mixture was incubated for a total 45 minutes at the temperatures listed in Table 2. At 5 minute intervals during the experiment, samples of the mixture were put on ice then immediately extracted with 80% ethanol and further processed as described in Example 3. Resuspended fractions were then analyzed by HPLC. Peaks appearing at approximately 35, 39, and 42 minutes could be identified as stachyose, raffinose, and sucrose, respectively. Maltohexaose or maltopentaose were used as an internal standard. Linear regression of time points of remaining stachyose and raffinose concentrations was performed to produce the rates in Table 2. From the data, as temperature decreases the rates at which stachyose and raffinose are removed from the meal and flake also decrease. This is to be expected given the temperature/activity profile of the enzyme.

TABLE 2
Rate^{a,b} of Oligosaccharide Removal as a Function of Temperature

| | Soy Meal | | Soy Flake | |
|---|---|---|---|---|
| Temperature | Stachyose | Raffinose | Stachyose | Raffinose |
| 90° C. | 1.50 | 5.70 | 1.25 | 4.50 |
| | (0.951)^{c} | (0.967) | (0.829) | (0.999) |
| 80° C. | 0.76 | 2.69 | 0.84 | 3.28 |
| | (0.903) | (0.996) | (0.936) | (0.975) |
| 70° C. | Negligible | 1.71 | Negligible | 1.56 |
| | | (0.926) | | (0.675) |

^{a}Experiments conducted at 70% excess moisture with 50 U of α-Gal
^{b}Rates given as % oligosaccharide removed min⁻¹ g material⁻¹ U α-Gal⁻¹
^{c}Numbers in parentheses denote R² values of a given experiment

The effect of moisture content on direct TmGalA digestion of soy meal and soy flake is illustrated in Table 3. Experiments were conducted under similar conditions as described above except that the temperature was fixed at 90° C. and the moisture level allowed to vary as shown in Table 3. Prior to incubation at 90° C., variation in moisture level was achieved by incubation of the soy meal/flake-α-Gal mixture at 45° C. under vacuum until the appropriate moisture level was obtained. Following this treatment, experiments were conducted as described above. From the data in Table 3 it is apparent that moisture content does not greatly affect the rate of α-Gal digestion soy meal and soy flake presumably until some critical moisture level is reached.

TABLE 3
Rate^{a,b} of Oligosaccharide Removal as a Function of Excess
Moisture Content

| | |
|---|---|
| Soy Meal | Soy Flake |

| Moisture | Stachyose | Raffinose | Stachyose | Raffinose |
|---|---|---|---|---|
| 70% | 1.50 | 5.70 | 1.25 | 4.50 |
| | (0.951)^{cc} | (0.967) | (0.829) | (0.999) |
| 45% | 1.70 | 2.91 | 1.74 | Not Determined |
| | (0.9541) | (0.769) | (0.966) | |
| 25% | 1.26 | 5.20 | 1.26 | Not Determined |
| | (0.915) | (0.943) | (0.918) | |
| 10% | — | — | — | — |

^{a}Experiments conducted at 90° C. with 50 U of α-Gal
^{b}Rates given as % oligosaccharide removed min⁻¹ g material⁻¹ U α-Gal⁻¹
^{c}Numbers in parentheses denote R² values of given experiment

### EXAMPLE 5

### Summary of Results

The α-galactosidase (GalA) from Thermotoga maritima (Tm) DSM3 109 has been successfully cloned and preliminarily characterized. The enzyme has an optimum pH between about 4.5-5.0 and a temperature optimum of about 85-90° C. The enzyme is active with PNP-galactose, raffinose (DP3), stachyose (DP4), and verbascose (DP5). Tm GalA specific activity with various substrates are given in Table 1. Furthermore, the enzyme was shown to have a half-life of 70 minutes at pH 7 and 90° C., indicating an ability to survive the steam treatment steps during feed processing. Additionally, Tm GalA exhibited only 3% of its maximal activity on PNP-galactose at 25° C. (pH 4.5), suggesting that room temperature Tm GalA activity on higher degree of polymerization raffino-oligosaccharides may be minimal.

Initial Tm GalA digests of high protein content and high carbohydrate content chicken feeds produced positive results. Tm GalA digestion of solubilized, ethanol extracted chicken feed components showed that the enzyme was effective in removing what we have putatively identified as stachyose from the feed. The removal of soluble stachyose from raw, untreated chicken feed was also observed.

The foregoing is illustrative of the present invention and is not to be construed as limiting thereof. The invention is defined by the following claims, with equivalents of the claims to be included therein.

That which is claimed is:

1. A method of hydrolyzing a galactose-containing oligosaccharide present in a substrate, comprising:
contacting the substrate with a hyperthermophilic α-galactosidase isolated from the group consisting of Thermotoga maritima, Thermotoga elfii, and Thermotoga sp. T2; and
heating the substrate to a temperature at which the hyperthermophilic α-galactosidase is active, for a period of time sufficient to hydrolyze the oligosaccharide.

2. The method of claim 1, wherein the oligosaccharide is selected from the group consisting of raffinose, stachyose and verbascose.

3. The method of claim 1, wherein the substrate is animal feed.

4. The method of claim 1, wherein the substrate is soybean meal.

5. The method of claim 1, wherein the substrate is human food.

6. The method of claim 1, wherein the hyperthermophilic α-galactosidase is isolated from Thermotoga maritima.

7. The method of claim 1, wherein the hyperthermophilic α-galactosidase is isolated from Thermotoga maritima DSM3109.

8. The method of claim 1, wherein the oligosaccharide is hydrolyzed into galactose monomers.

9. The method of claim 1, wherein the method is carried out under conditions of 70% moisture.

10. The method of claim 1, wherein the method is carried out under conditions of 25% moisture.

11. The method of claim 1, wherein the heating occurs at 80° C.

12. The method of claim 1, wherein the heating occurs at 85° C.

13. The method of claim 1, wherein the heating occurs at 90° C.

14. The method of claim 1, wherein the heating occurs at 100° C.

15. The method of claim 1, wherein the hyperthermophilic α-galactosidase is produced by:
(a) culturing a host cell comprising an expression vector containing a polynucleotide sequence encoding an hyperthermophilic α-galactosidase;
(b) expressing the hyperthermophilic α-galactosidase; and
(c) recovering the hyperthermophilic α-galactosidase from the host cell culture.

16. The method of claim 15, wherein the polynucleotide has the sequence of SEQ ID NO: 1.

17. The method of claim 15, wherein the polynucleotide is selected from the group consisting of
(a) DNA having the nucleotide sequence of SEQ ID NO: 1;
(b) polynucleotides that encode an hyperthermophilic α-galactosidase and hybridize to DNA of (a) above under stringent conditions; and
(c) polynucleotides that encode an hyperthermophilic α-galactosidase and differ from the DNA of (a) or (b) above due to the degeneracy of the genetic code.

18. The method according to claim 15 wherein the polynucleotide encodes an hyperthermophilic α-galactosidase having the amino acid sequence of SEQ ID NO: 2.

19. A method of preparing an animal feed composition comprising a hydrolyzed galactose-containing oligosaccharide, comprising:
contacting ingredients of the animal feed composition with a hyperthermophilic α-galactosidase during the processing of the animal feed,
wherein the hyperthermophilic α-galactosidase is contacted with the animal feed ingredients prior to a heating step in the animal feed processing for a period of time sufficient to allow the hyperthermophilic α-galactosidase to hydrolyze the galactose-containing oligosaccharide; and
wherein the hyperthermophilic α-galactosidase is isolated from the group consisting of Thermotoga maritima, Thermotoga elfii, and Thermotoga sp. T2.

20. The method of claim 19, wherein said galactose-containing oligosaccharide is selected from the group consisting of raffinose, stachyose and verbascose.

21. The method of claim 19, wherein the animal feed comprises soybean meal.

22. The method of claim 19, wherein the animal feed comprises soybean flakes.

23. The method of claim 19, wherein the animal feed is chicken feed.

24. The method of claim 19, wherein the hyperthermophilic α-galactosidase is isolated from Thermotoga maritima.

25. The method of claim 19, wherein the hyperthermophilic α-galactosidase is isolated from Thermotoga maritima DSM3109.

26. The method of claim 19, wherein the oligosaccharide is hydrolyzed into galactose monomers.

27. The method of claim 19, wherein the contacting of the hyperthermophilic α-galactosidase with the ingredients of the animal feed composition is carried out under conditions of 70% moisture.

28. The method of claim 19, wherein the contacting of the hyperthermophilic α-galactosidase with the ingredients of the animal feed composition is carried out under conditions of 25% moisture.

29. The method of claim 19, wherein the contacting of the hyperthermophilic α-galactosidase with the ingredients of the animal feed composition is carried out under conditions of 45% moisture.

30. The method of claim 19, wherein the heating step occurs at 80° C.

31. The method of claim 19, wherein the heating step occurs at 85° C.

32. The method of claim 19, wherein the heating step occurs at 90° C.

33. The method of claim 19, wherein the heating step occurs at 100° C.

34. The method of claim 19, wherein the contacting of the ingredients of the animal feed composition with the hyperthermophilic α-galactosidase occurs prior to a final pelleting step in the animal feed processing.

35. The method of claim 19, wherein the hyperthermophilic α-galactosidase is produced by:
(a) culturing a host cell comprising an expression vector containing a polynucleotide sequence encoding an hyperthermophilic α-galactosidase;
(b) expressing the hyperthermophilic α-galactosidase; and
(c) recovering the hyperthermophilic α-galactosidase from the host cell culture.

36. The method of claim 35, wherein the polynucleotide has the sequence of SEQ ID NO: 1.

37. The method of claim 35, wherein the polynucleotide is selected from the group consisting of
(a) DNA having the nucleotide sequence of SEQ ID NO: 1;
(b) polynucleotides that encode an hyperthermophilic α-galactosidase and hybridize to DNA of (a) above under stringent conditions; and
(c) polynucleotides that encode an hyperthermophilic α-galactosidase and differ from the DNA of (a) or (b) above due to the degeneracy of the genetic code.

38. The method according to claim 35 wherein the polynucleotide encodes an hyperthermophilic α-galactosidase having the amino acid sequence of SEQ ID NO: 2.

39. The method according to claim 19, wherein the hyperthermophilic α-galactosidase is in liquid solution when the hyperthermophilic α-galactosidase is contacted with the ingredients of the animal feed composition.

40. The method according to claim 19, wherein the hyperthermophilic α-galactosidase is in dried form when the hyperthermophilic α-galactosidase is contacted with the ingredients of the animal feed composition.

41. The method according to claim 19, wherein the hyperthermophilic α-galactosidase is partially purified when the hyperthermophilic α-galactosidase is contacted with the ingredients of the animal feed composition.

42. The method according to claim 19, wherein the hyperthermophilic α-galactosidase is in substantially purified form when the hyperthermophilic α-galactosidase is contacted with the ingredients of the animal feed composition.

43. An animal feed produced according to the method of claim 19.

44. A food additive for the reduction of gastrointestinal distress in mammals, comprising a hyperthermophilic α-galactosidase isolated from the group consisting of Thermotoga maritima, Thermotoga elfii, and Thermotoga sp. T2.

45. The food additive of claim 44, wherein the hyperthermophilic α-galactosidase is isolated from Thermotoga maritima.

46. The food additive of claim 44, wherein the hyperthermophilic α-galactosidase is isolated from Thermotoga maritima DSM3109.

47. The food additive of claim 44, wherein the hyperthermophilic α-galactosidase is produced by:
(a) culturing a host cell comprising an expression vector containing a polynucleotide sequence encoding an hyperthermophilic α-galactosidase;
(b) expressing the hyperthermophilic α-galactosidase; and
(c) recovering the hyperthermophilic α-galactosidase from the host cell culture.

48. The food additive of claim 47, wherein the polynucleotide has the sequence of SEQ ID NO: 1.

49. The food additive of claim 47, wherein the polynucleotide is selected from the group consisting of
(a) DNA having the nucleotide sequence of SEQ ID NO: 1;
(b) polynucleotides that encode an hyperthermophilic α-galactosidase and hybridize to DNA of (a) above under stringent conditions; and
(c) polynucleotides that encode an hyperthermophilic α-galactosidase and differ from the DNA of (a) or (b) above due to the degeneracy of the genetic code.

50. The food additive according to claim 47 wherein the polynucleotide encodes an hyperthermophilic α-galactosidase having the amino acid sequence of SEQ ID NO: 2.

51. A method of preventing gastrointestinal distress in a mammal, wherein the gastrointestinal distress is caused by food containing at least one oligosaccharide selected from the group consisting of raffinose, stachyose and verbascose, comprising:
contacting the food with a hyperthermophilic α-galactosidase isolated from the group consisting of Thermotoga maritima, Thermotoga elfii, and Thermotoga sp. T2; and then
heating the food for a period of time sufficient to allow the hyperthermophilic α-galactosidase to hydrolyze the oligosaccharide.

52. A processing additive for the removal of galactose-containing oligosaccharides in a process of making edible soybean protein, comprising a hyperthermophilic α-galactosidase isolated from the group consisting of Thermotoga maritima, Thermotoga elfii, and Thermotoga sp. T2.

53. A method of removing galactose-containing oligosaccharides from a soybean substrate being processed to produce an edible soybean protein, comprising:
contacting the soybean substrate with a hyperthermophilic α-galactosidase isolated from the group consisting of Thermotoga maritima, Thermotoga elfii, and Thermotoga sp. T2;
heating the soybean substrate at a temperature and for a length of time sufficient to hydrolyze the galactose-containing oligosaccharides; and
removing the hydrolyzed galactose-containing oligosaccharides from the soybean substrate prior to a final extraction or fractionation of the edible soybean protein.

54. The method of claim 53, wherein the heating occurs prior to the removal of oil from the soybean substrate.

55. The method of claim 53, wherein the heating occurs after the removal of oil from the soybean substrate.

56. The method of claim 53, wherein the soybean substrate is soybean flakes.

57. An isolated edible soybean protein produced by the method of claim 53.


SEQUENCE LISTING (2 sequences)

SEQ ID NO: 1 - DNA, 1659 bp, Thermotoga maritima
  CDS (1)..(1659)
atggaaatattcggaaagaccttcagagagggaagattcgttctcaaagagaaaaacttcacagttgagttcgcggtggagaagatacaccttggctggaagatctccggcagggtgaagggaagtccgggaaggcttgaggttcttcgaacgaaagcaccggaaaaggtacttgtgaacaactggcagtcctggggaccgtgcagggtggtcgatgccttttctttcaaaccacctgaaatagatccgaactggagatacaccgcttcggtggtgcccgatgtacttgaaaggaacctccagagcgactatttcgtggctgaagaaggaaaagtgtacggttttctgagttcgaaaatcgcacatcctttcttcgctgtggaagatggggaacttgtggcatacctcgaatatttcgatgtcgagttcgacgactttgttcctcttgaacctctcgttgtactcgaggatcccaacacaccccttcttctggagaaatacgcggaactcgtcggaatggaaaacaacgcgagagttccaaaacacacacccactggatggtgcagctggtaccattacttccttgatctcacctgggaagagaccctcaagaacctgaagctcgcgaagaatttcccgttcgaggtcttccagatagacgacgcctacgaaaaggacataggtgactggctcgtgacaagaggagactttccatcggtggaagagatggcaaaagttatagcggaaaacggtttcatcccgggcatatggaccgccccgttcagtgtttctgaaacctcggatgtattcaacgaacatccggactgggtagtgaaggaaaacggagagccgaagatggcttacagaaactggaacaaaaagatatacgccctcgatctttcgaaagatgaggttctgaactggcttttcgatctcttctcatctctgagaaagatgggctacaggtacttcaagatcgactttctcttcgcgggtgccgttccaggagaaagaaaaaagaacataacaccaattcaggcgttcagaaaagggattgagacgatcagaaaagcggtgggagaagattctttcatcctcggatgcggctctccccttcttcccgcagtgggatgcgtcgacgggatgaggataggacctgacactgcgccgttctggggagaacatatagaagacaacggagctcccgctgcaagatgggcgctgagaaacgccataacgaggtacttcatgcacgacaggttctggctgaacgaccccgactgtctgatactgagagaggagaaaacggatctcacacagaaggaaaaggagctctactcgtacacgtgtggagtgctcgacaacatgatcatagaaagcgatgatctctcgctcgtcagagatcatggaaaaaaggttctgaaagaaacgctcgaactcctcggtggaagaccacgggttcaaaacatcatgtcggaggatctgagatacgagatcgtctcgtctggcactctctcaggaaacgtcaagatcgtggtcgatctgaacagcagagagtaccacctggaaaaagaaggaaagtcctccctgaaaaaaagagtcgtcaaaagagaagacggaagaaacttctacttctacgaagagggtgagagagaatga

SEQ ID NO: 2 - protein, 552 aa, Thermotoga maritima
MEIFGKTFREGRFVLKEKNFTVEFAVEKIHLGWKISGRVKGSPGRLEVLRTKAPEKVLVNNWQSWGPCRVVDAFSFKPPEIDPNWRYTASVVPDVLERNLQSDYFVAEEGKVYGFLSSKIAHPFFAVEDGELVAYLEYFDVEFDDFVPLEPLVVLEDPNTPLLLEKYAELVGMENNARVPKHTPTGWCSWYHYFLDLTWEETLKNLKLAKNFPFEVFQIDDAYEKDIGDWLVTRGDFPSVEEMAKVIAENGFIPGIWTAPFSVSETSDVFNEHPDWVVKENGEPKMAYRNWNKKIYALDLSKDEVLNWLFDLFSSLRKMGYRYFKIDFLFAGAVPGERKKNITPIQAFRKGIETIRKAVGEDSFILGCGSPLLPAVGCVDGMRIGPDTAPFWGEHIEDNGAPAARWALRNAITRYFMHDRFWLNDPDCLILREEKTDLTQKEKELYSYTCGVLDNMIIESDDLSLVRDHGKKVLKETLELLGGRPRVQNIMSEDLRYEIVSSGTLSGNVKIVVDLNSREYHLEKEGKSSLKKRVVKREDGRNFYFYEEGERE